(19) United States
(12) Patent Application Publication
(10) Pub. No.: US 2026/0124109 A1
(43) Pub. Date: May 7, 2026

(54) SUCTION CUP FOR A CHEST COMPRESSION DEVICE

(71) Applicant: PHYSIO-CONTROL, INC., Redmond, WA (US)

(72) Inventors: Marcus Ehrstedt, Kävlinge (SE); Wiktor Kocula, Löderup (SE); Lars Anders Jörgen Segerstein, Staffanstorp (SE); Tobias Svahn, Malmö (SE); Per Axelsson, Åkarp (SE); Eric Sandrup, Lund (SE); Jon Bylund, Lund (SE); Sara Lindroth, Lund (SE); Josefine Carlsson, Kävlinge (SE); Kristian Solem, Trelleborg (SE); Jonas Lagerström, Fagersanna (SE); Johan Nordström, Helsingborg (SE); Thomas Falk, Staffanstorp (SE); Erik von Schenck, Lomma (SE)

(21) Appl. No.: 19/376,158

(22) Filed: Oct. 31, 2025

Related U.S. Application Data
(60) Provisional application No. 63/715,427, filed on Nov. 1, 2024.

(51) Int. Cl. A61H 31/00

(52) U.S. Cl. CPC A61H 31/006; A61H 2031/001; A61H 2201/123; A61H 2201/1619; A61H 2201/1669; A61H 2203/0456; A61H 2205/084

(57) ABSTRACT

A device for applying compressions to a chest of a patient has a suction cup configured to contact the chest of the patient. The device also has a valve configured to allow air to exit or to enter a cavity through a boundary of the suction cup, the cavity being between the suction cup and the chest of the patient, and the device has a pump configured to evacuate the cavity through the valve.

### CROSS-REFERENCE TO RELATED APPLICATIONS

This patent application claims the benefit of provisional Application No. 63/715,427 filed Nov. 1, 2024, which application is incorporated into the present disclosure by this reference.

### TECHNICAL FIELD

This disclosure is directed to systems and methods related to mechanical cardiopulmonary resuscitation (CPR) devices, and, more particularly, to suction cups for a mechanical CPR device and detection of suction cup attachment.

### BACKGROUND

Mechanical CPR has several advantages over manual CPR. A person performing CPR, such as a medical first-responder, must exert considerable physical effort to maintain proper compression timing and depth. Over time, fatigue can set in and compressions can become less consistent and less effective. The person performing CPR must also divert mental attention to performing manual CPR properly and may not be able to focus on other tasks that could help the patient. For example, a person performing CPR at a rate of 100 compressions per minute would likely not be able to simultaneously prepare a defibrillator for use to attempt to correct the patient's heart rhythm. Mechanical compression devices can be used with CPR to perform compressions that would otherwise be done manually. Mechanical compression devices can provide advantages such as providing constant, proper compressions for sustained lengths of time without fatiguing, freeing medical personnel to perform other tasks besides CPR compressions, and being usable in smaller spaces than would be required by a person performing CPR compressions.

Some conventional CPR devices utilize a suction cup to attach a piston to a chest of a patient for performing CPR compressions and decompressions. Specifically, these suction cups are beneficial for lifting the chest of a patient back to an original position before performing another compression. However, suction cups are generally designed to stick or attach to polished, flat, and hard surfaces, while a chest of a patient has curves in multiple directions. It can thus be difficult to adequately attach a suction cup to the topography of a patient's chest, and suction cups designed for CPR devices often have high walls and large internal volumes to adequately attach. But the higher the walls and the larger the internal volume of a suction cup, the greater the force needed to empty the air and create a pressure seal against the patient's chest. Generating enough force to create a reliable pressure seal without damaging a patient's skin can pose a difficulty.

Configurations of the disclosed technology address shortcomings in the prior art.

### BRIEF DESCRIPTION OF THE DRAWINGS

FIG. 1 is a perspective view of a CPR device, according to an example configuration.

FIG. 2 is a front view of the CPR device of FIG. 1, also showing a representation of a patient within the CPR device.

FIG. 3 is a perspective view of a suction cup and pump for implementation with a CPR device, according to an example configuration.

FIG. 4 is a cross-sectional view of the suction cup of FIG. 3.

FIG. 5 is a perspective view of a suction cup and pump for implementation with a CPR device, according to an additional example configuration.

FIG. 6 is a cross-sectional view of the suction cup of FIG. 5.

FIG. 7 is a perspective view of a suction cup and pump for implementation with a CPR device, according to an additional example configuration.

FIG. 8 is a cross-sectional view of the suction cup of FIG. 7.

FIG. 9 is a perspective view of a suction cup having an integral pump for implementation with a CPR device, according to an example configuration.

FIG. 10 is a cross-sectional view of the suction cup of FIG. 9.

FIG. 11 is a perspective view of a sensor arrangement for a CPR device suction cup, according to an example configuration.

FIG. 12 is a perspective view of a sensor arrangement for a CPR device suction cup, according to an additional example configuration.

FIG. 13 is a perspective view of a sensor arrangement for a CPR device suction cup, according to an example configuration.

FIG. 14 is a perspective view of a suction cup having a flexible lip for evacuating air for implementation with a CPR device, according to an example configuration.

FIG. 15 is a cross-sectional view of the suction cup of FIG. 14, before air is evacuated.

FIG. 16 is a cross-sectional view of the suction cup of FIG. 14, while air is being evacuated.

FIG. 17 is a cross-sectional view of a suction cup for implementation with a CPR device, according to an example configuration.

FIG. 18 illustrates an example schematic block diagram of portions of a mechanical compression device system, according to configurations.

### DETAILED DESCRIPTION

Configurations of the disclosure are directed to suction cups for mechanical CPR devices with increased suction, and, accordingly, increased attachment force to the chest of a patient. Specifically, configurations of the disclosed suction cups implement valves for emptying the air contents out of the inner cavities of the suction cups, decreasing the pressure within the suction cups. Configurations of the disclosed suction cups also implement sensors for detecting detachment from the chest of a patient, as well as other parameters measured during performance of automatic CPR compressions.

CPR treatment is a dynamic process and suction cups are usually created from a relatively soft material. This means that during decompression, or other times when the suction cup is being lifted when adhered to the patient's chest, the negative pressure within the suction cup can be higher than the negative pressure (relative to 1 atm) created in a static state (when the suction cup is attached to a surface an not subjected to any lifting force) since the suction cup stretches when lifted at decompression increasing the volume inside the suction cup. Accordingly, other configurations of the disclosed suction cups also or instead implement valves for adding air into the inner cavities of the suction cups, thereby increasing the pressure within the suction cups, but without reducing the attachment force to zero. Accordingly, the lifting force of the suction cup on the patient's chest can be limited.

Suction cups attach to surfaces by creating a partial vacuum. Specifically, when air or another fluid is removed from the internal cavity of a suction cup, negative fluid pressure of air in the internal cavity relative to the higher ambient pressure outside the suction cup seals the suction cup to the surface and maintains the seal until air or another fluid is allowed back into the internal cavity. Known CPR devices remove air from the internal cavity of the suction cup by pressing the suction cup to a patient's chest, creating a seal with negative pressure. However, as mentioned, emptying enough air to generate a reliable seal on the uneven topography of a patient's chest can be difficult. Configurations of the disclosed suction cups are emptied more completely than known CPR device suction cups sealed by pressing the suction cups against a patient's chest, and thus configurations of the disclosed suction cups yield lower pressures within the suction cups and greater attachment forces to patients' chests.

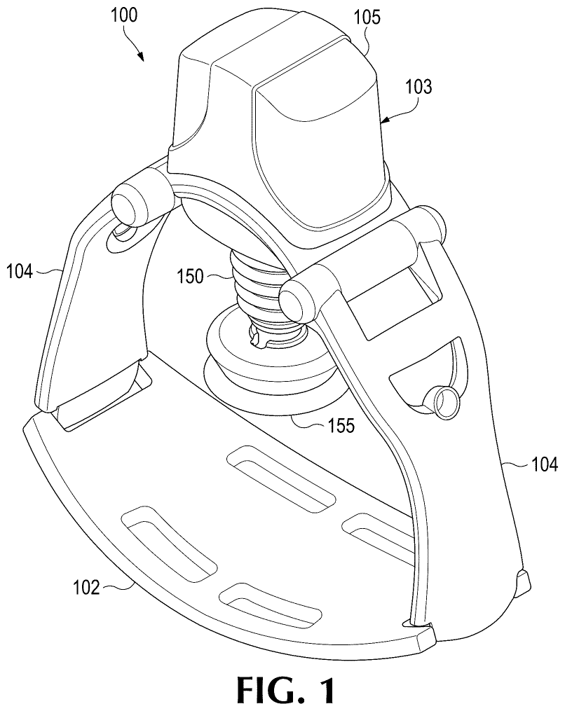

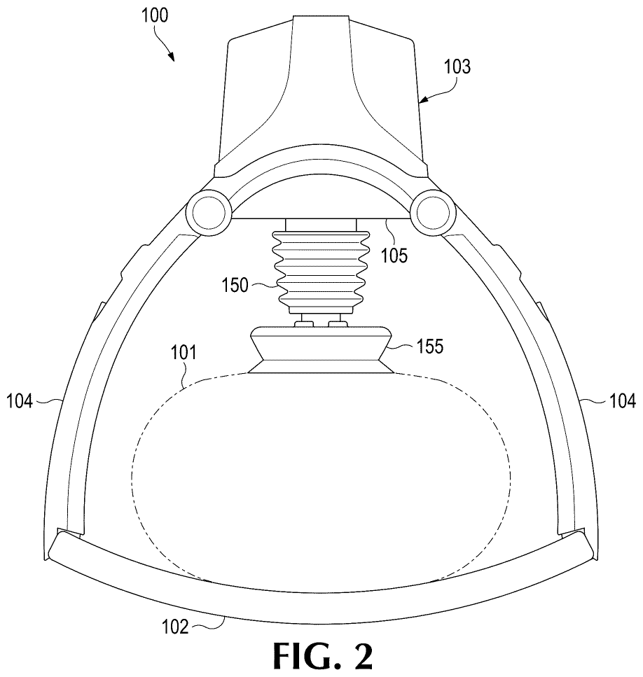

FIG. 1 is a perspective view showing portions of a CPR device 100, according to configurations. FIG. 2 is a front view of the CPR device 100 of FIG. 1, also showing a representation of a patient 101 within the CPR device 100. As illustrated in FIGS. 1 and 2, a CPR device 100 may include a base member 102, a chest compression mechanism 103, and a support leg 104. The base member 102 is sometimes referred to as a backboard or a backplate.

The chest compression mechanism 103 may be configured to deliver CPR chest compressions to the patient 101. The chest compression mechanism 103 may include, for example, a housing 105 a motor-driven piston 150 configured to contact the patient's chest to provide the CPR chest compressions, the motor-driven piston 150 further including a suction cup 155 to attach to the chest of a patient.

The support leg 104 may be configured to support the chest compression mechanism 103 at a distance from the base member 102. For example, if the base member 102 is underneath the patient 101, who is lying on the patient's back, then the support leg 104 may support the chest compression mechanism 103 at a sufficient distance over the base member 102 to allow the patient 101 to lay within a space between the base member 102 and the chest compression mechanism 103, while positioning the chest compression mechanism 103 over the patient's chest.

In configurations, there may be two support legs 104. In configurations, the two support legs 104 may together form an arch to support the chest compression mechanism 103. An example of such a configuration is illustrated in FIG. 1-2. As will be understood by one skilled in the art, the mechanical CPR device 100 may include additional components not shown in FIG. 1-2.

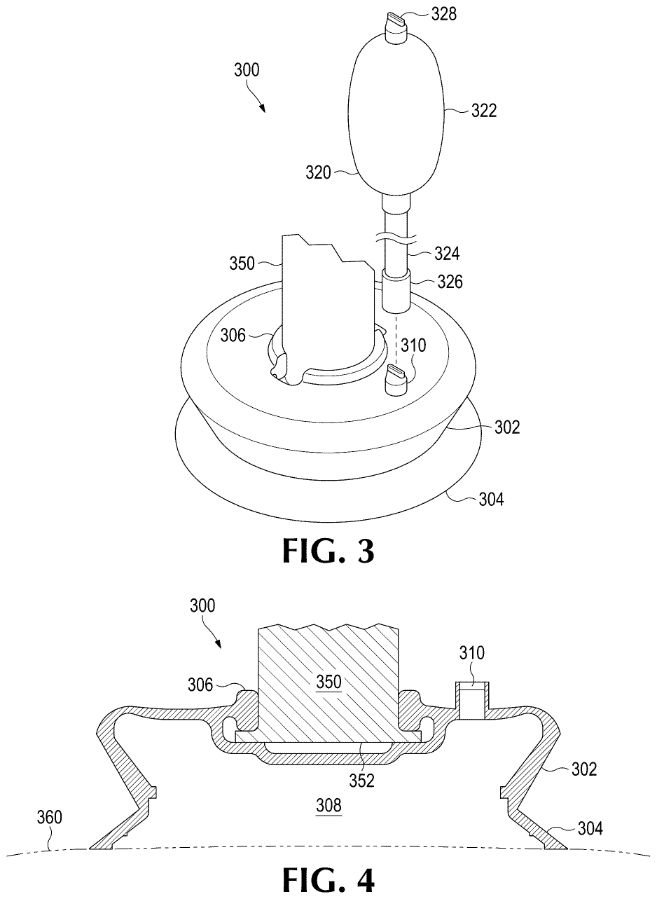

FIG. 3-4 illustrate a suction cup 300 for implementation with a CPR device, according to configurations. In configurations, suction cup 300 is implemented with a CPR device similar to the example illustrated in FIG. 1-2. However, suction cup 300 is not limited to use with such a CPR device, and still other implementations of suction cup 300 are possible. As shown in FIG. 3, suction cup 300 has outer walls 302, a sealing lip 304, and a piston lip 306. Piston lip 306, in configurations, is configured to contact and create a seal with piston 350, maintaining the suction cup 300 at an end of piston 350 during use of the CPR device. Additionally, suction cup 300 includes a valve 310. In configurations, valve 310 is a one-way valve structured to allow flow of air from inside the suction cup 300 toward the ambient air around the suction cup 300 but prohibit any flow of air into the suction cup 300. Finally, as shown in FIG. 3, valve 310 is configured to interface with a pump 320 to empty the contents of suction cup 300.

Pump 320, in configurations, has a flexible bulb 322, a tube 324, and a connector 326 for connecting the tube 324 to the valve 310. In this way, when pump 320 is connected to valve 310, pump 320 and the contents of suction cup 300 are fluidically connected. Put differently, when pump 320 is connected to valve 310, air is capable of flowing from the interior of suction cup 300 to tube 324, then to flexible bulb 322, described in further detail below. Pump 320 also includes a pump valve 328. In configurations, pump valve 328 is a one-way valve structured to allow a flow of air from inside the flexible bulb 322 toward the ambient air but prohibit any flow of air into the flexible bulb 322. Accordingly, the flow path of air described above cannot be reversed when the pump 320 is connected to suction cup 300. That is, air will not flow from flexible bulb 322 toward the interior of suction cup 300.

FIG. 4 shows a cross-sectional view of suction cup 300, according to configurations of the disclosure. As illustrated, suction cup 300 has an internal cavity 308. When suction cup 300 is implemented with a CPR device and attached to a patient's chest, represented as surface 360 in FIG. 4, internal cavity 308 comprises the volume substantially enclosed by the surface 360 and the geometry of the suction cup 300—namely, the outer walls 302 and sealing lip 304. For the purposes of this disclosure, “substantially enclosed” means largely or essentially surrounded on all sides, without requiring perfect encasement.

Suction cup 300, in configurations, is made of silicone rubber or elastomer. Nonetheless, in still other configurations, suction cup 300 is made of any suitably deformable material, such that the volume of internal cavity 308 can be changed by deforming outer walls 302 and/or sealing lip 304. Additionally, one skilled in the art will understand that, although portions of suction cup 300 are deformable such that the volume of internal cavity 308 can be changed, as described, not all portions of suction cup 300 must be deformable. Put differently, configurations of suction cup 300 are made of a combination of materials, both elastic and non-elastic.

In use, suction cup 300 is attached to piston 350 at the terminal end 352. As shown in FIG. 4, suction cup 300 fits around the terminal end 352 of piston 350 such that piston lip 306 interfaces with terminal end 352 and creates a seal. When suction cup 300 is attached, piston 350 is brought toward a patient's chest such that sealing lip 304 of suction cup 300 contacts the patient's chest. Suction cup 300 is then pressed against the patient's chest, causing air within internal cavity 308 to escape via valve 310, decreasing the pressure within internal cavity 308 and forming a seal between sealing lip 304 and surface 360. As mentioned, in configurations, valve 310 is a one-way valve, and air thus cannot reenter internal cavity 308 through valve 310.

To further decrease pressure within internal cavity 308, pump 320 is connected to suction cup 300 via connector 326. Once connected, a rescuer squeezes flexible bulb 322, causing air within flexible bulb 322 to escape via pump valve 328. As mentioned, in configurations, pump valve 328 is also a one-way valve, and air thus cannot reenter flexible bulb 322 through pump valve 328. Consequently, when the rescuer releases flexible bulb 322, flexible bulb 322 will tend to refill with air but can only receive air flowing from internal cavity 308. Any air remaining within internal cavity 308 will thus flow through valve 310 and tube 324 until it reaches and refills flexible bulb 322. If pressure within the internal cavity 308 must be further decreased to create a stronger seal between sealing lip 304 and surface 360, the process of squeezing and releasing flexible bulb 322 to pull air from internal cavity 308 may be repeated.

Because pump 320 can be repeatedly used to further empty air from internal cavity 308, pressure within suction cup 300 can be decreased more than known CPR suction cup devices relying on pressing against a patient's chest alone to form a pressure seal. Specifically, in configurations, suction cup 300 implemented with valve 310 and pump 320 can decrease pressure within internal cavity 308 four times more than pressing suction cup 300 against a patient's chest alone. Thus, suction cup 300 implemented with valve 310 and pump 320 yields a greater attachment force against a patient's chest, allowing suction cup 300 to be attached to topographically uneven chests more reliably than known CPR device suction cups.

Furthermore, because pump 320 is removably attachable from valve 310, and because valve 310 is a one-way valve, in configurations, pump 320 can be removed from suction cup 300 when a desired seal and attachment force is created, before automatic CPR compressions are performed. Accordingly, when automatic CPR compressions are performed, pump 320 can be moved away from the travel path of piston 350, preventing any potential damage to pump 320.

In configurations, flexible bulb 322 of pump 320 is made of silicone rubber or elastomer to allow deformation of flexible bulb 322. In additional or alternative configurations, pump 320 is made of any suitably deformable material. The stiffness of flexible bulb 322 will influence the maximum attachment force that can be reached. That is, a stiffer pump may create a larger pressure difference between the internal cavity 308 and the ambient air than a softer pump. Accordingly, in any configuration, material can be chosen for flexible bulb 322 with a desired maximum attachment force in mind, and a desired maximum attachment force may be chosen with prevention of damage to the patient's skin as a consideration. Additionally, in some configurations, a spring is incorporated with flexible bulb 322 to aid the elastic material of flexible bulb 322 to return to its original shape to be deformed once again. Still other components of pump 320, such as tube 324 and connector 326, are formed of a non-elastic material like plastic, in configurations.

Although pump 320 is illustrated in FIG. 3, it should be noted that still other components can be used to empty the contents of suction cup 300 and decrease its pressure, in configurations. For instance, in configurations, a fixed-volume syringe is implemented. In such configurations, the fixed-volume syringe can be connected with valve 310 such that air is permitted to flow from the suction cup 300, through valve 310, and into fixed-volume syringe. Once connected, a rescuer can pull the syringe plunger, causing air within suction cup 300 to pass through valve 310 and fill the volume of the fixed-volume syringe. As air enters the fixed-volume syringe, pressure decreases within suction cup 300, creating the strong pressure seal with the patient's chest as described above with regard to FIG. 3-4. In some configurations implementing a fixed-volume syringe as pump 320, the fixed-volume syringe includes a spring positioned at an end of the fixed-volume syringe a rescuer pulls the syringe plunger toward. In such configurations, the spring is configured to bias the plunger toward the valve 310, ultimately preventing the plunger from being pulled so far as to exert an undesirably large attachment force on the patient's chest.

In still other configurations, pump 320 is an electric pump driven by a battery or a wire electrically connected to another device, such as the CPR device, to use the other device as a power source. Additionally or alternatively, pump 320 is a venturi tunnel system in configurations. More specifically, configurations of pump 320 comprise a hose driven by compressed air, the compressed air configured to reduce air pressure at the valve 310 and cause air to escape via valve 310.

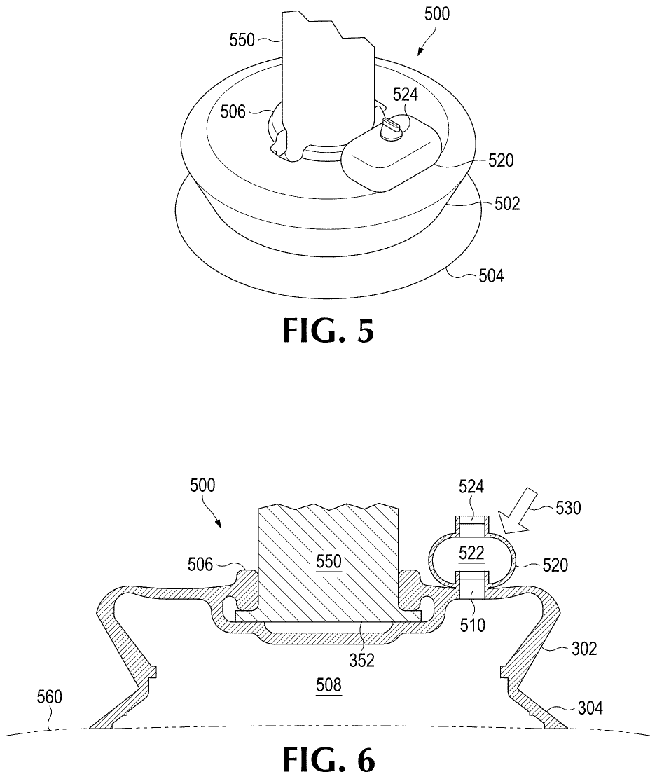

FIG. 5-6 illustrate a suction cup 500 for implementation with a CPR device, according to an additional configuration of the disclosure. Specifically, FIG. 5 shows a perspective view of suction cup 500, and FIG. 6 shows a cross-sectional view of suction cup 500 attached to a patient's chest, represented as surface 560. As described with regard to suction cup 300 of FIG. 3-4, suction cup 500 can be implemented with a CPR device similar to the example illustrated in FIG. 1-2 but need not be limited to use with such a CPR device. Additionally, similar to the example described with regard to FIG. 3-4, suction cup 500 has outer walls 502, a sealing lip 504, and a piston lip 506.

As shown in FIG. 5, suction cup 500 has a removable pump 520. Removable pump 520 is structured to be deformable and substantially hollow. For the purposes of this disclosure “substantially hollow” means largely or essentially empty, without requiring perfect vacancy. For instance, as shown in FIG. 6, removable pump 520 has a chamber 522 that is largely or essentially empty. Additionally, removable pump 520 is structured to fit over a valve 510 of suction cup 500 and be removably attachable to valve 510. Valve 510, in configurations, is a one-way valve structured to allow flow of air from an interior cavity 508 of suction cup 500 toward chamber 522 of removable pump 520 but prohibit any flow of air into the internal cavity 508 from the removable pump 520.

Rather, removable pump 520 also has a pump valve 524, which is also a one-way valve, in configurations. Pump valve 524 is thus structured to allow air to flow from chamber 522 to the ambient surroundings but prohibit air from flowing into chamber 522 from the ambient surroundings. In this way, when removable pump 520 is connected to valve 510, removable pump 520 and the interior cavity 508 of suction cup 500 are fluidically connected, and air is capable of flowing interior cavity 508, to chamber 522, to the ambient surroundings, as described in further detail below.

In use, suction cup 500 is attached to piston 550 at the terminal end 552. Similar to the example configuration described above with regard to FIG. 4, suction cup 500 fits around the terminal end 552 of piston 550 such that piston lip 506 interfaces with terminal end 552 and creates a seal. When suction cup 500 is attached, piston 550 is brought toward a patient's chest such that sealing lip 504 contacts the patient's chest. Suction cup 500 is then pressed against the patient's chest, causing air within internal cavity 508 to escape via valve 510, decreasing the pressure within the internal cavity 508 and forming a seal between sealing lip 504 and surface 560.

As mentioned, removable pump 520 is removably attachable to valve 510. Put differently, removable pump 520 can be attached to or removed from suction cup 500 at any point during preparation for CPR compressions. If removable pump 520 is already attached when suction cup 500 is pressed against the patient's chest, air escaping internal cavity 508 will escape into chamber 522. A rescuer can then apply a force to removable pump 520 in a direction indicated by arrow 530. When the rescuer applies this force, air within chamber 522 escapes via pump valve 524. If removable pump 520 is not already attached when suction cup 500 is pressed against the patient's chest, air escaping internal cavity 508 will escape into the ambient surroundings. A rescuer can then attach removable pump 520 and apply the force indicated with arrow 530 to further decrease the pressure within internal cavity 508.

Because pump valve 524 is also a one-way valve, in configurations, air cannot reenter removable pump 520 through pump valve 524. Consequently, when the rescuer releases the applied force on removable pump 520, chamber 522 will tend to refill with air but can only receive air flowing from internal cavity 508. Air remaining within internal cavity 508 will thus flow through valve 510 and into chamber 522, refilling chamber 522 and further decreasing pressure within internal cavity 508. If pressure within the internal cavity 508 must be further decreased to create a stronger seal between sealing lip 504 and surface 560, force can once again be applied to removable pump 520 to repeat the process of pulling air out of internal cavity 508.

When a desired pressure within internal cavity 508 is reached, removable pump 520 can be removed from suction cup 500. Alternatively, removable pump 520 can be left attached to suction cup 500 without concern that removable pump 520 will enter the travel path of piston 550. More specifically, the small structure of removable pump 520 relative to the suction cup 500 and the attachment of removable pump 520 over valve 510 ensures that removable pump 520 remains stationary during compressions. Indeed, although removable pump 520 has been described as removably attachable to suction cup 500, in still other configurations, a pump similar to removable pump 520 is permanently fixed to suction cup 500.

In configurations, removable pump 520 is made of the same material as the suction cup 500 to allow adequate deformation of removable pump 520 when a force is applied. In additional or alternative configurations, removable pump 520 is made of any other suitably deformable material.

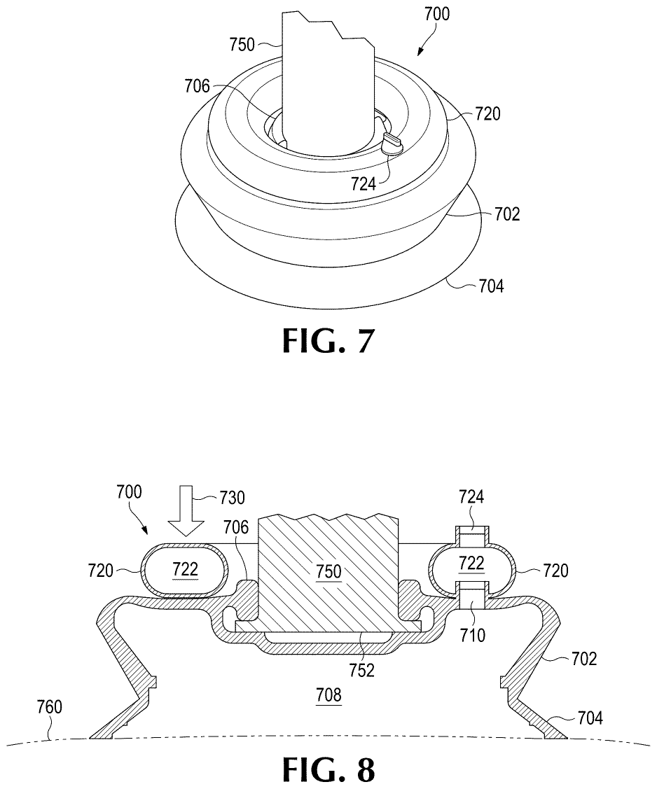

FIG. 7-8 illustrate a suction cup 700 for implementation with a CPR device, according to an additional configuration of the disclosure. FIG. 7 specifically shows a perspective view of suction cup 700, and FIG. 8 shows a cross-sectional view of suction cup 700 attached to a surface 760, representing the chest of a patient. Similar to the example suction cups just described with regard to FIG. 3-6, suction cup 700 can be implemented with a CPR device, such as the example illustrated in FIG. 1-2. But suction cup 700 need not be limited to uses with such a CPR device. Additionally, similar to the examples described with regard to FIG. 3-6, suction cup 700 has outer walls 702, a sealing lip 704, and a piston lip 706.

Best illustrated in FIG. 7, suction cup 700 has a toroidal pump 720. Toroidal pump 720 is shaped to be substantially toroidal and substantially surround piston 750 when suction cup 700 is attached. For the purposes of this disclosure, “substantially toroidal” means largely or essentially forming a ring, without requiring a perfect ring shape, and “substantially surround” means largely or essentially forming a closed plane curve rotated about a line, without requiring perfect toroidal shape. Toroidal pump 720 is also substantially hollow, in configurations. Accordingly, toroidal pump 720 has a chamber 722 that is largely or essentially empty, spanning the entire substantially toroidal shape of pump 720, and toroidal pump 720 is accessible to a rescuer from any side of suction cup 700. Additionally, toroidal pump 720 interfaces with suction cup 700 at a valve 710. Put differently, toroidal pump 720 is structured to fit over valve 710 and fluidically connect chamber 722 with internal cavity 708 of suction cup 700. In configurations, valve 710 is a one-way valve structured to allow flow of air from interior cavity 708 into chamber 722 but prohibit any flow of air in the opposite direction.

Toroidal pump 720 instead has a pump valve 724 structured to allow air to flow from chamber 722 to the ambient surroundings. Pump valve 724, in configurations, is also a one-way valve. Thus, when toroidal pump 720 is attached to suction cup 700, air can flow from interior cavity 708, to chamber 722, to the ambient surroundings, but no air can enter chamber 722—and subsequently, interior cavity 708—from the ambient surroundings.

In use, suction cup 700 is attached to piston 750 at the terminal end 752, similar to the example configurations described above with regard to FIGS. 4 and 6. When suction cup 700 is attached, piston 750 is brought toward a patient's chest such that sealing lip 704 contacts the patient's chest. Suction cup 700 is then pressed against the patient's chest, causing air from internal cavity 708 to escape via valve 710, decreasing the pressure within the internal cavity 708 and forming a seal between sealing lip 704 and surface 760.

Toroidal pump 720, in configurations, is removably attachable to valve 710. In other words, toroidal pump 720 can be attached or removed from suction cup 700 at any point before the performance of CPR compressions. For instance, if toroidal pump 720 is attached when suction cup 700 is pressed against the patient's, air flowing out of internal cavity 708 and through valve 710 will enter chamber 722. A rescuer can then apply a force to toroidal pump 720 in a direction indicated by arrow 730, causing air within chamber 722 to escape to the ambient surroundings via pump valve 724. If toroidal pump 720 is not already attached when suction cup 700 is pressed against the patient's chest, air escaping internal cavity 708 will escape into the ambient surroundings. A rescuer can then attach toroidal pump 720 and apply the force indicated with arrow 730 to further decrease the pressure within internal cavity 708.

As mentioned, pump valve 724 is also a one-way valve, in configurations of suction cup 700. When the rescuer releases the applied force on toroidal pump 720, chamber 722 thus tends to refill with air. However, chamber 722 can only receive air flowing from internal cavity 708, and air remaining within internal cavity 708 will flow through valve 710 to refill chamber 722 and further decrease the pressure within internal cavity 708. If pressure within the internal cavity 708 must be further decreased to create a stronger seal between sealing lip 704 and surface 760, force can once again be applied to toroidal pump 720, and the process of pulling air from internal cavity 708 can be repeated.

When a desired pressure within internal cavity 708 is reached, toroidal pump 720 can either be removed from suction cup 700, or it can be left attached to suction cup 700 without concern. Indeed, although toroidal pump 720 has been described as removably attachable to suction cup 700, in still other configurations, a pump similar to toroidal pump 720 is permanently fixed to suction cup 700.

Additionally, although one valve 710 and one pump valve 724 are shown in FIG. 7-8, configurations of suction cup 700 have a greater number of valves disposed around the substantially toroidal shape of toroidal pump 720, allowing for more uniform removal of air from interior cavity 708 and deformation of suction cup 700 compared to a single valve. Additionally, in configurations of toroidal pump 720 that are removable, multiple valves disposed around the substantially toroidal shape of toroidal pump 720 yield a more secure connection between toroidal pump 720 and suction cup 700.

In configurations, toroidal pump 720 is made of the same material as suction cup 700 to allow adequate deformation of toroidal pump 720 when a force is applied. In additional or alternative configurations, toroidal pump 720 is made of any other suitably deformable material.

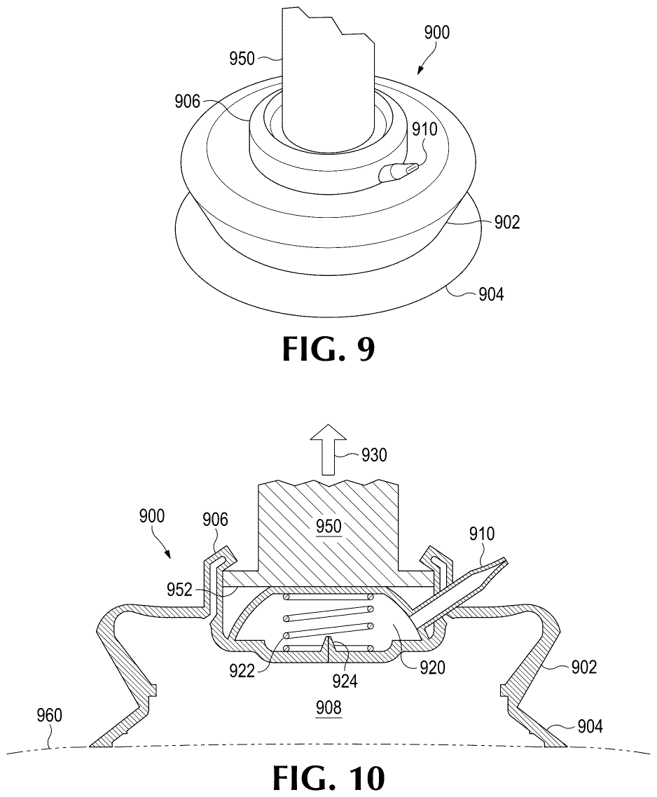

FIG. 9-10 illustrate a suction cup 900, according to yet another configuration of the disclosure. FIG. 9 shows a perspective view of suction cup 900, and FIG. 10 shows a cross-sectional view of suction cup 900, revealing further internal details of suction cup 900. As with the example suction cups described above with regard to FIG. 3-8, suction cup 900 can be implemented with a CPR device, such as the one shown in FIG. 1-2. Nonetheless, suction cup 900 need not be limited to uses with such a CPR device, and still other implementations of suction cup 900 are possible. Additionally, similar to the examples described above, suction cup 900 has outer walls 902, a sealing lip 904, and a piston lip 906.

Suction cup 900, similar to the example suction cups described above, has a valve 910. In configurations, valve 910 is a one-way valve configured to allow air to escape the contents of suction cup 900 but not enter the suction cup 900 from the ambient surroundings. Suction cup 900 also includes an integral pump 920, best illustrated in FIG. 10. As shown, integral pump 920 is contained within an envelope of the suction cup 900—that is, integral pump 920 need not be attached or assembled with suction cup 900, and integral pump 920 is ready for use whenever suction cup 900 is attached to terminal end 952 of piston 950. Integral pump 920 includes a spring 922, positioned within integral pump 920 aligned with a central axis of piston 950, and integral pump 920 also includes a pump valve 924. Aside from the presence of spring 922, integral pump 920 is substantially hollow. Pump valve 924, in configurations, is a one-way valve that allows air to flow from interior cavity 908 into integral pump 920 but prohibits flow of air from integral pump 920 into interior cavity 908. Accordingly, with both pump valve 924 and valve 910 present on suction cup 900, air flows from interior cavity 908, to integral pump 920, to the ambient surroundings. Air is prohibited by valve 910 and pump valve 924 from flowing the opposite direction.

In use, suction cup 900 is attached to piston 950 at the terminal end 952, similar to the example configurations described above with regard to FIGS. 4, 6, and 8. When suction cup 900 is attached, piston 950 is brought toward a patient's chest such that sealing lip 904 contacts the patient's chest, represented as surface 960 in FIG. 10. Suction cup 900 is then pressed against the patient's chest, causing air from internal cavity 908 to escape via pump valve 924 into integral pump 920. This initial escape of air from internal cavity 908 decreases the pressure within the internal cavity 908 and forms a seal between sealing lip 904 and surface 960.

In configurations, a CPR device implementing suction cup 900 can initially cycle through low amplitude compressions and chest lifts to ensure suction cup 900 is attached to the patient's chest. In other words, piston 950 is initially driven to travel short distances toward and away from the patient's chest, represented as surface 960. When piston 950 is driven toward surface 960, spring 922 compresses and air within integral pump 920 escapes through valve 910 to the ambient surroundings, decreasing pressure within integral pump 920. When piston 950 is driven away from surface 960, spring 922 expands. As spring 922 expands, integral pump 920 tends to refill with air, and thus expansion of spring 922 causes air to flow from internal cavity 908 to integral pump 920 through pump valve 924. Consequently, as a CPR device implementing suction cup 900 continues to cycle through these low amplitude compressions, the process of removing air from internal cavity 908 through integral pump 920 repeats and further decreases the pressure within internal cavity 908, creating a strong seal between sealing lip 904 and surface 960.

When a desired pressure within internal cavity 908 is reached, the CPR device can be controlled to perform CPR compressions alternating with chest lifts. As CPR compressions and chest lifts are performed, the presence of integral pump 920 within suction cup 900 helps maintain an adequate seal. For instance, if a compression or lift disrupts the seal between sealing lip 904 and surface 960 and causes an increase in pressure within internal cavity 908, a subsequent compression and lift will engage integral pump 920 as described above to once again empty internal cavity 908 and decrease its pressure. In additional or alternative configurations, the CPR device can include a user interface configured to receive manual input from a user. In such configurations, in the event that suction cup 900 detaches from a patient's chest, a rescuer can provide input that controls the CPR device to return to its initial low amplitude cycling of compressions and lifts to reattach suction cup 900.

Additionally, as best shown in FIG. 10, piston lip 906 is structured such that emptying air from internal cavity 908 using integral pump 920 causes piston lip 906 to suck inward to hold suction cup 900 to terminal end 952 of piston 950. Put differently, evacuating internal cavity 908 and deforming suction cup 900, accordingly, causes piston lip 906 to fold around terminal end 952 and ensure suction cup 900 remains attached to terminal end 952.

In configurations, integral pump is formed of the same material as suction cup 900, and spring 922 is any industry standard spring of a desired spring constant. In configurations, a spring constant can be selected for spring 922 considering a maximum amount of attachment force to be generated.

A CPR device implementing a suction cup according to any of the configurations discussed above with regard to FIG. 3-10 yields a greater attachment force than known suction cups that are attached solely by being pressed against a patient's chest. With greater attachment force, configurations of the disclosed suction cups create strong, reliable pressure seals with patients'chests. Accordingly, regardless of a patient's size or the unevenness of the patient's chest topography, configurations of the disclosed suction cups can attach to a patient's chest and remain attached during cycles of compressions and decompressions.

Nonetheless, any of the disclosed suction cup examples can be implemented with sensors for detecting proper attachment to a patient's chest. Specifically, in configurations, pressure sensors can be implemented with a suction cup to measure the air pressure inside the suction cup. Because air pressure inside the suction cup must be less than the pressure of the suction cup's ambient surroundings, pressure measurements made inside the suction cup can indicate whether the difference between pressure inside the suction cup and ambient pressure outside of the suction cup is sufficient to maintain a pressure seal with the patient's chest. In addition to pressure sensors, configurations of the disclosure implement a variety of sensors with suction cups for measuring a variety of parameters during performance of CPR compressions.

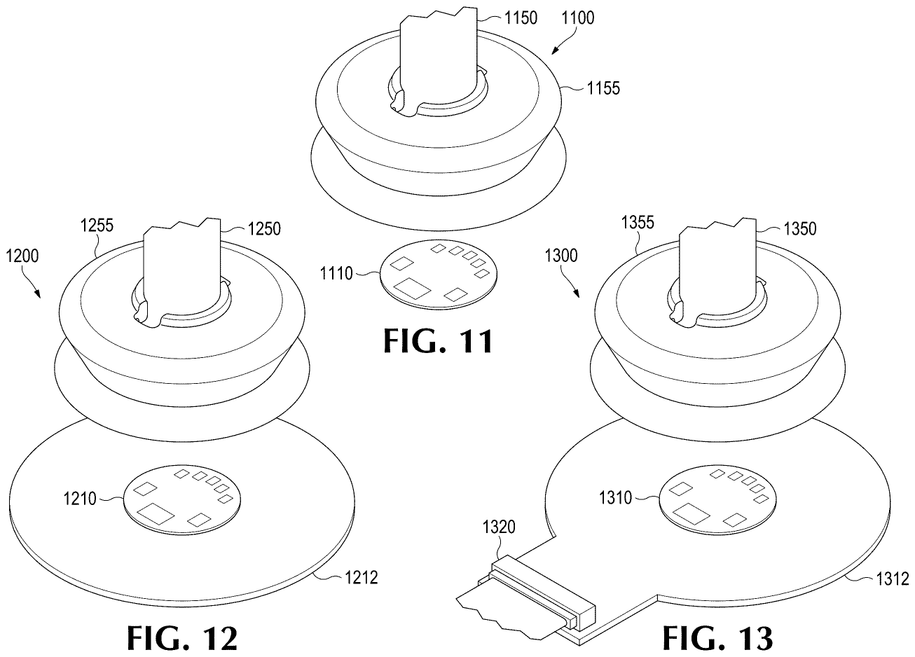

For instance, FIG. 11 illustrates a sensor arrangement 1100 for implementation with a CPR device, according to configurations. Specifically, FIG. 11 shows a sensor package 1110 that can be placed between a suction cup 1155 and the chest of a patient when the suction cup 1155 is attached to an end of a piston 1150. In configurations, sensor package 1110 is small enough to fit within the inside the volume of suction cup 1155. That is, sensor package 1110 is sized such that it does not extend past the circumference of suction cup 1155 when placed between suction cup 1155 and a patient's chest. Additionally, in configurations, sensor package 1110 is attached to an inner surface of suction cup 1155, such as the surface of suction cup 1155 opposite where piston 1150 interfaces with suction cup 1155. In this way, configurations of sensor package 1110 are part of suction cup 1155 as one unit.

Sensor package 1110, in configurations, is in wireless communication with a CPR device. Accordingly, Bluetooth™ or other known short range communication protocols can be used to communicate measurements taken by sensor package 1110 with a controller and/or microprocessor driving the CPR device. Nonetheless, in still other configurations, sensor package 1110 is in communication with a CPR device via a wired connection.

As mentioned, sensor package 1110 comprises one or more pressure sensors for measuring the pressure within suction cup 1155. In use, suction cup 1155 having sensor package 1110 is attached to piston 1150, and piston 1150 is brought toward a patient's chest. Suction cup 1155 is then pressed against the patient's chest to form a pressure seal, and the pressure seal is further strengthened according to any of the methods of evacuating the contents of suction cup 1155 described above with regard to FIG. 3-10. With the suction cup 1155 firmly attached to the patient's chest, sensor package 1110 comprising one or more pressure sensors will read a pressure within suction cup 1155 that is lower than standard atmospheric pressure or other ambient pressure outside of the suction cup 1155. Sensor package 1110 can then output a signal to be received by the controller and/or microprocessor driving operations of the CPR device, the output signal indicating the measured pressure. In configurations, the CPR device has a preset maximum pressure for verifying adequate attachment of the suction cup 1155 to the patient's chest. In other words, the controller and/or microprocessor can be configured to determine that the suction cup 1155 is adequately attached as long as pressure measurements received from sensor package 1110 are below the preset maximum value.

During performance of CPR compressions, sensor package 1110 can continue to measure pressure within suction cup 1155 and output signals indicating the measured pressure. If the pressure seal formed between suction cup 1155 is disturbed, the output signals from sensor package 1110 will indicate that pressure within the suction cup 1155 has increased. In configurations, the controller and/or microprocessor of the CPR device stores an initial pressure measurement upon attachment of the suction cup 1155 and has a preset threshold to determine whether suction cup 1155 has detached or begun to detach, the preset threshold having a maximum acceptable difference relative to the stored initial pressure. That is, the controller and/or microprocessor can be configured to determine that the suction cup 1155 is detached or has begun to detach if a pressure measurement received from sensor package 1110 exceeds the preset threshold. In configurations, the preset threshold is the preset maximum pressure for verifying adequate attachment of the suction cup 1155, discussed above. In still other configurations, the controller and/or microprocessor of the CPR device is configured to determine that suction cup 1155 has detached when a pressure measurement received from sensor package 1110 is equal to standard atmospheric pressure or other ambient pressure outside of the suction cup 1155.

When the controller and/or microprocessor of the CPR device determines that suction cup 1155 has detached from the chest of the patient, the CPR device can output a human perceptible alert, in configurations. In some examples, the human perceptible alert comprises an audible sound like an alarm or a verbal indication that the suction cup has detached. Additionally or alternatively, the human perceptible alert comprises a visual cue, such as a flashing light or a readable message indicating that the suction cup has detached. Still other human perceptible alerts may be implemented, in configurations, to alert a rescuer that the suction cup has detached. In still other configurations, the controller and/or microprocessor is configured to stop and/or briefly pause CPR compressions when it is determined that the suction cup has detached from the chest of the patient.

Although pressure sensors have been described, sensor package 1110 comprises a variety of other sensors, in configurations. For instance, in configurations, sensor package 1110 comprises sensors for measuring patient physiological parameters during performance of CPR compressions. Sensor package 1110 may thus comprise sensors for measuring blood flow and sensors for reading SpO₂ to monitor blood oxygen saturation. In additional or alternative configurations, sensor package 1110 comprises motion sensors, such as accelerometers, for measuring movement of the piston 1150 and/or suction cup 1155 during CPR compressions.

FIG. 12 shows a sensor arrangement 1200 for implementation with a CPR device, according to additional configurations of the disclosure. Similar to the example shown in FIG. 11, sensor arrangement 1200 has a sensor package 1210 to be placed between a suction cup 1255 and the chest of a patient when the suction cup 1255 is attached to an end of a piston 1250. However, rather than being a standalone component, sensor package 1210 is attached to a sensor plate 1212. Sensor plate 1212, in configurations, is sized such that it extends past the circumference of suction cup 1255 when placed between suction cup 1255 and a patient's chest. Sensor plate 1212 is also substantially rigid, in configurations. For the purposes of this disclosure, “substantially rigid” means largely or essentially stiff and not pliant, without requiring perfect inflexibility. Although not illustrated in FIG. 12, sensor plate 1212 is configured to be adhered to a patient's chest, in configurations. For instance, an adhesive pad or sheet can be included with a portion of sensor plate 1212 that interfaces with a patient's chest.

Because sensor plate 1212 is substantially rigid and is configured to be adhered to a patient's chest, sensor plate 1212 provides a more even surface for suction cup 1255 to attach to, compared with the patient's chest alone. Accordingly, a CPR device implementing sensor arrangement 1200 can create a particularly strong and reliable pressure seal with suction cup 1255.

In configurations, sensor package 1210 comprises one or more pressure sensors for measuring the pressure within suction cup 1255 when suction cup 1255 is attached to sensor plate 1212. In use, sensor package 1210 can verify attachment of suction cup 1255 to sensor plate 1212 or determine that suction cup 1255 has detached or begun to detach from sensor plate 1212 according to any of the measurement methods described above with regard to sensor package 1110 of FIG. 11. And, in additional or alternative configurations, sensor package 1210 comprises a variety of other sensors, such as the sensors for measuring patient physiological parameters or motion sensors described above.

FIG. 13 shows a sensor arrangement 1300 for implementation with a CPR device, according to additional configurations of the disclosure. Similar to the discussed above with regard to FIG. 11-12, sensor arrangement 1300 has a sensor package 1310 to be placed between a suction cup 1355 and the chest of a patient when the suction cup 1355 is attached to an end of a piston 1350. Sensor package 1310 is also attached to a sensor plate 1312, which is substantially rigid and can be adhered to a patient's chest similar to the example sensor plate shown in FIG. 12, in configurations. Accordingly, a CPR device implementing sensor arrangement 1300 can create a particularly strong and reliable pressure seal with suction cup 1355 due to the even surface provided by sensor plate 1312.

As illustrated in FIG. 13, sensor plate 1312 also includes a power system 1320. In configurations, power system 1320 comprises a rechargeable battery for powering the sensor package 1310. In configurations having a power system 1320 comprising a rechargeable battery, sensor package 1310 will have a longer battery life than sensor packages lacking power system 1320. In still other configurations, power system 1320 is a wire interface for directly connecting sensor plate 1312 to a power source. Consequently, in configurations having a power system 1320 comprising a wire interface, sensor package 1310 can be used without concern of exhausting battery life during performance of CPR compressions.

In configurations, sensor package 1310 comprises one or more pressure sensors for measuring the pressure within suction cup 1355 when suction cup 1355 is attached to sensor plate 1312. In use, sensor package 1310 can verify attachment of suction cup 1355 to sensor plate 1312 or determine that suction cup 1355 has detached or begun to detach from sensor plate 1212, according to any of the measurements described above with regard to sensor package 1110 of FIG. 11. And, in additional or alternative configurations, sensor package 1310 comprises a variety of other sensors, such as the sensors for measuring patient physiological parameters or motion sensors described above.

The sensor packages described above, according to the examples described with regard to FIG. 11-13, need not be limited to sensor functionality. Put differently, configurations of the sensor packages described above also include other devices to be utilized in coordination with automatic CPR compressions. As an example, configurations of the sensor packages described above incorporate a defibrillator pad, allowing for defibrillation in conjunction with CPR compressions. In general, known defibrillator pads are not designed for use with automatic CPR devices, and they can interfere with a piston's ability to consistently compress a patient's chest in a desired location. Additionally or alternatively, configurations of the sensor packages described above incorporate a flexible ultrasound transceiver array on a side of the sensor package interfacing with the patient's chest. Such configurations incorporating a flexible ultrasound transceiver array can thus provide non-invasive imaging of a patient's heart during performance of automatic CPR compressions.

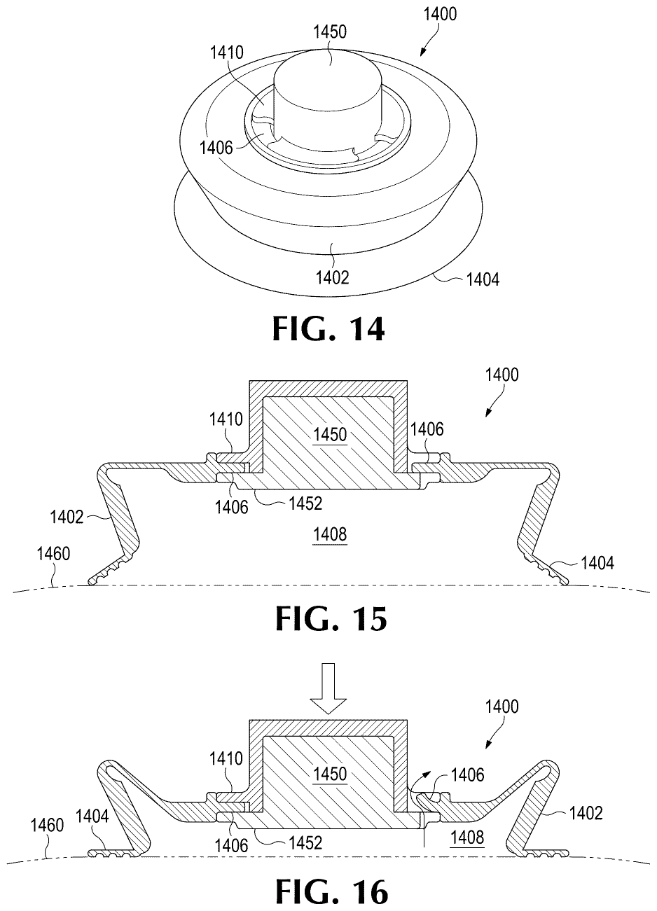

FIG. 14-16 illustrate a suction cup 1400 for implementation with a CPR device, according to another example configuration of the disclosure. FIG. 14 shows a perspective view of the suction cup 1400, and FIG. 15-16 show cross sectional views of suction cup 1400 attached to a surface 1460, before and during evacuation of the suction cup 1400, respectively. Similar to the example suction cups described above with regard to FIG. 3-10, suction cup 1400 can be implemented with a CPR device and attached to an end of a piston 1450, similar to the example CPR devices shown in FIG. 1-2. Suction cup 1400 need not be limited to uses with such a CPR device, however. Suction cup 1400 also has outer walls 1402, a sealing lip 1404, and a piston lip 1406, similar to the examples described above.

In configurations implementing suction cup 1400, piston lip 1406 is structured to act as a one-way valve where the piston lip 1406 interfaces with piston 1450, and pressing suction cup 1400 onto a surface 1460, such as a patient's chest, causes air to escape from piston lip 1406. Piston lip 1406 is a flexible component extending laterally from an upper portion of suction cup 1400 toward piston 1450, and, in configurations, piston lip 1406 is a unitary extension of material disposed about the full circumference of piston 1450. That is, piston lip 1406 substantially surrounds piston 1450 when suction cup 1400 is attached to piston 1450. In still other configurations, piston lip 1406 is a plurality of extensions disposed about the circumference of piston 1450 rather than a unitary extension. As shown in FIG. 14, piston 1450 also has interface extensions 1410. In particular, interface extensions 1410 comprise a substantially rigid material extending laterally from an outer surface of piston 1450. In configurations, interface extensions 1410 do not extend from the entire circumference of piston 1450. Rather, interface extensions 1410 are spaced around the circumference of piston 1450, with portions of piston 1450 having no extensions.

Best illustrated in FIG. 15, suction cup 1400 is attached to piston 1450 at the terminal end 1452. When suction cup 1400 is attached to piston 1450, piston lip 1406 is structured to sit over the terminal end 1452 and form a seal, with interface extensions 1410 of piston 1450 sitting over piston lip 1406. As shown, and as mentioned, interface extensions 1410 do not extend from the entire circumference of piston 1450. Consequently, one of interface extensions 1410 is illustrated as sitting over piston lip 1406, whereas a portion of piston lip 1406 on an opposite side of piston 1450 has no interface extensions sitting over it. Spacing interface extensions 1410 with portions of piston 1450 having no extensions, in this way, allows portions of piston lip 1406 to lift off terminal end 1452 and allow air to escape internal cavity 1408, while other portions of piston lip 1406 are kept against terminal end 1452. Put differently, portions of piston lip 1406 that are not covered by interface extensions 1410 act as a one-way valve.

FIG. 16 illustrates the evacuation of internal cavity 1408 through piston lip 1406 acting as a one-way valve. Specifically, when piston 1450 is brought toward a surface 1460, such as a patient's chest, air is forced out of internal cavity 1408. As air is forced out, portions of piston lip 1406 covered by interface extensions 1410 do not allow piston lip 1406 to lift. Rather, portions of piston lip 1406 covered by interface extensions 1410 remain against terminal end 1452 of piston 1450. Other portions of piston lip 1406 that are not covered by interface extensions 1410, however, are deformed by the escaping air. In other words, air leaving internal cavity 1408 tends to lift the uncovered portions of piston lip 1406 so that the air can escape to the ambient surroundings. Removing air from internal cavity 1408 thus decreases the pressure within internal cavity 1408, creating a strong seal between sealing lip 1404 and surface 1460.

Because piston lip 1406 is structured to substantially surround piston 1450, and thus interface with the entire circumference of terminal end 1452, terminal end 1452 prevents air from reentering internal cavity 1406. Put differently, although uncovered portions of piston lip 1406 can bend and lift off terminal end 1452 away from internal cavity 1408, the presence of terminal end 1452 prevents any portion of piston lip 1406 from bending the opposite direction. Accordingly, once air is evacuated from internal cavity 1408, piston lip 1406 tends to suck inward to hold suction cup 1400 to terminal end 1452, ensuring suction cup 1400 remains attached to terminal end 1452.

As previously mentioned, a CPR device implementing a suction cup according to the example configurations illustrated in FIGS. 14-16 yields a greater attachment force compared to known suction cups. Thus, configurations of the disclosed suction cups create strong, reliable pressure seals with patients'chests, regardless of the patient's chest topography. Additionally, as mentioned above with regard to the example suction cups of FIGS. 3-10, suction cup 1400 can be implemented with sensors for detecting proper attachment to a patient's chest. Specifically, sensors can be implemented by any of the means discussed with regard to FIGS. 11-13 to measure the pressure within suction cup 1400 or a variety of other parameters during performance of CPR compressions.

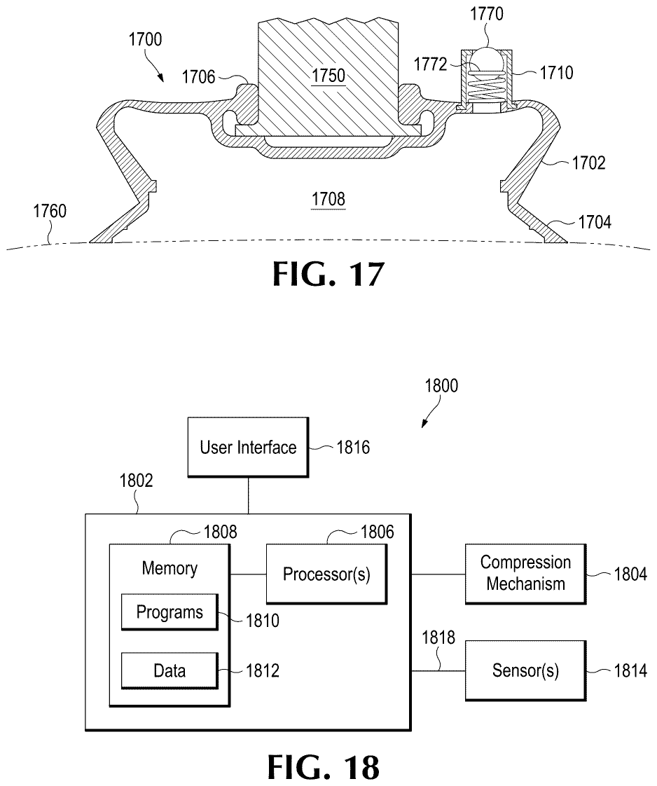

In addition to or instead of any of the valves discussed above for FIG. 1-16, configurations may include a valve that allows air into the suction cup. Accordingly, FIG. 17 is a cross-sectional view of a suction cup for implementation with a CPR device, according to an example configuration having a vale that allows air into the suction cup.

In configurations, suction cup 1700 is implemented with a CPR device similar to the example CPR device 100 illustrated in FIG. 1-2. However, suction cup 1700 is not limited to use with such a CPR device. The suction cup 1700 of FIG. 17 is largely similar to the suction cup 300 of FIG. 4, except as noted here.

As shown in FIG. 17, suction cup 1700 has outer walls 1702, a sealing lip 1704, and a piston lip 1706. The outer walls 1702 and the sealing lip 1704 surround an internal cavity 1708, which is also bounded by the patient's chest 1760. Piston lip 1706, in configurations, is configured to contact and create a seal with piston 1750, maintaining the suction cup 1700 at an end of piston 1750 during use of the CPR device. Additionally, suction cup 1700 includes a valve 1710.

In configurations, the valve 1710 is a one-way valve structured to allow air to flow from the ambient air that surrounds the suction cup 1700 into the internal cavity 1708 of the suction cup 1700 but prohibit any flow of air out of the suction cup 1700. Air is introduced into the cavity 1708 to increase an air pressure within the cavity 1708 to an amount that is less than an ambient pressure outside the boundary of the suction cup 1700. In configurations, the valve 1710 permits the air pressure within the cavity 1708 to be increased without reducing the attachment force of the suction cup 1700 to zero. In other words, the pressure is increased, but the suction cup 1700 remains adhered to the patient's chest 1760. This is accomplished by closely controlling how much ambient air is permitted to enter the internal cavity 1708 of the suction cup 1700. In this way, the lifting force of the suction cup 1700 on the patient's chest 1760 can be limited to, for example, avoid injury to the patient.

As illustrated in FIG. 17, the valve 1710 may be a ball valve that includes a ball 1770 or similar coupled to a spring 1772. Preferably, the spring 1772 is pretensioned to keep the ball 1770 seated until a minimum force is exerted by the ambient air pressure on the ball 1770, causing the ball 1770 to unseat and allow air past the ball 1770 and into the cavity 1708. In other configurations, the valve 1710 might be a duck bill valve, an umbrella valve, or simply a hole in the outer walls 1702 or the sealing lip 1704 the suction cup 1700.

In other configurations, the valve 1710 is a two-way valve structured to allow air to flow from the ambient air that surrounds the suction cup 1700 into the internal cavity 1708 of the suction cup 1700 and to allow the flow of air out of the internal cavity 1708 of the suction cup 1700 and into the ambient air.

The valve 1710 discussed here for FIG. 17 can be substituted for any of the valves 310, 510, and 710 discussed above for FIG. 3-8. Accordingly, the valve 1710 may be used in conjunction with a pump to assist with introducing air into the internal cavity 1708 of the suction cup 1700. In configurations, where the valve 1710 is a two-way valve, the pump may assist with both introducing air into the internal cavity 1708 and removing air from the internal cavity 1708.

The suction cup 1700 discussed here for FIG. 17 can be used with the sensor arrangements discussed above for FIG. 11-13.

FIG. 18 illustrates an example schematic block diagram of portions of a mechanical compression device system 1800. The mechanical compression device system 1800 of FIG. 18 may be, for example, the mechanical CPR device 100 of FIG. 1-2. As will be understood by one skilled in the art, the mechanical compression system 1800 may include additional components not shown in FIG. 18. Further, the components of the mechanical compression device system 1800 may not be included in the same device, but rather may be located in different parts of the mechanical compression device system 1800 and communicate either by wired or wireless signals. The mechanical compression device system 1800 includes a controller 1802, which may be in electrical communication with a compression mechanism 1804, which may include a piston (such as the piston 150 of FIG. 1-2 or other pistons described in this disclosure) and a suction cup or pressure pad (such as the suction cup 155 of FIG. 1-2 or other suction cups as described in this disclosure). While a single controller 1802 is shown for ease, multiple controllers 1802 may operate together to accomplish the various features discussed in this disclosure.

The controller 1802 provides instructions to the compression mechanism 1804 to operate the compression mechanism 1804 at a number of different rates, waveforms, depths, heights, duty cycles or combinations thereof that change over time. Accordingly, the compression mechanism 1804 may include a driver coupled to the piston and configured to extend the piston toward the chest of the patient and to retract the piston away from the chest of the patient. Example chest or abdomen manipulation instructions or protocols include compressing a chest and decompressing or expansions of a chest.

The controller 1802 may include one or more processors 1806, which may be implemented as any processing circuity, such as, but not limited to, a microprocessor, an application specific integration circuit (ASIC), programmable logic circuits, etc. The controller may further include a memory 1808 coupled with the processor 1806. Memory 1808 can include a non-transitory storage medium that includes programs 1810 configured to be read by the processor 1806 and be executed upon reading. The processor 1806 is configured to execute instructions from memory 1808 and may perform any methods and/or associated operations indicated by such instructions. Memory 1808 may be implemented as processor cache, random access memory (RAM), read only memory (ROM), solid state memory, hard disk drive(s), or any other memory type. Memory 1808 acts as a medium for storing data 1812, such as instructions for the compression mechanism 1804 based on a type of suction cup attached, event data, patient data, etc., computer program products, and other instructions.

Controller 1802 may further communicate with one or more sensors 1814. The controller 1802 can receive signals 1818 or other data from the sensor(s) 1814. The sensors 1814 may be any of the sensors discussed in this disclosure.

The controller 1802 may be located separately from the compression mechanism 1804 and may communicate with the compression mechanism 1804 through a wired or wireless connection. As mentioned above, the controller 1802 may include multiple controllers, such as one controller being located in the housing 105 of FIG. 1-2 and another controller being located within the backboard 102. However, examples of the disclosure are not limited to these configurations, and the controller(s) 1802 can be located anywhere within the system. In configurations, the controller 1802 also electrically communicates with a user interface 1816. As will be understood by one skilled in the art, the controller 1802 may also be in electronic communication with a variety of other devices, such as, but not limited to, a communication device, another medical device, etc.

Operations of the mechanical CPR device 1800 may be effectuated through the user interface 1816. The user interface 1816 may be external to or integrated with a display. In some examples, the user interface 1816 may include physical buttons, while in other examples, the user interface 1816 may be a touch-sensitive feature of a display. The user interface 1816 may be located on the mechanical CPR device 1800 or on a remote device, such as a smartphone, tablet, PDA, and the like, and is also in electronic communication with the controller 1802. In some examples, controller 1802 can receive a rate, a waveform, or depth input from the user interface 1816 and, responsive to the rate, the waveform, or depth input, cause the compression mechanism 1804 to move to adjust the rate, waveform, and/or depth of the compression, decompression, or expansions during a session.

### EXAMPLES

Illustrative examples of the disclosed technologies are provided below. A particular configuration of the technologies may include one or more, and any combination of, the examples described below.

Example 1 includes a device for applying compressions to a chest of a patient, the device comprising: a suction cup configured to contact the chest of the patient; a valve configured to allow air to exit a cavity through a boundary of the suction cup, the cavity being between the suction cup and the chest of the patient; and a pump configured to evacuate the cavity through the valve.

Example 2 includes the device of Example 1, further comprising a pressure sensor between the suction cup and the chest of the patient, the pressure sensor being configured to measure a pressure in the cavity between the suction cup and the chest of the patient.

Example 3 includes the device of Example 2, in which the pressure sensor includes a wireless transmitter configured to transmit pressure data that corresponds to the pressure in the cavity between the suction cup and the chest of the patient.

Example 4 includes the device of any of Examples 1-3, in which the valve is further configured to substantially prevent air from entering the cavity through the valve.

Example 5A includes the device of any of Examples 1-4, in which the valve is further configured to allow air to enter the cavity through a boundary of the suction cup. Example 5B includes the device of Example 5A, in which the valve is configured to allow air to enter the cavity to increase a pressure within the cavity to an amount that is less than an ambient pressure outside the boundary of the suction cup.

Example 6 includes the device of any of Examples 1-5, in which the pump is removably attached to the valve.

Example 7 includes the device of any of Examples 1-6, in which the pump is incorporated within an envelope of the suction cup.

Example 8 includes the device of any of Examples 1-7, in which the valve and the pump are removably attached to the suction cup as a single unit.

Example 9 includes the device of any of Examples 1-8, in which the pump is substantially toroidal and coupled to an upper surface of the suction cup.

Example 10 includes the device of any of Examples 1-9, in which the pump is a fixed-volume syringe, the fixed-volume syringe having a spring configured to prevent the fixed-volume syringe from evacuating the cavity beyond a threshold of safe attachment force.

Example 11 includes the device of any of Examples 1-10, in which the pump comprises a spring and bellows within the suction cup, the bellows configured to force air from the cavity through the valve, the spring configured to return the bellows to an uncompressed condition.

Example 12 includes the device of Example 11, in which the bellows is separated from the cavity by a valve that allows air to pass from the cavity into the bellows.

Example 13 includes a device for applying compressions to a chest of a patient, the device comprising: a suction cup configured to adhere to a sensor plate between the suction cup and the chest of the patient, the sensor plate having a lateral width that is greater than a lateral width of the suction cup, the pressure sensor being configured to measure a pressure in a cavity between the suction cup and the sensor plate; a valve configured to allow air to exit the cavity through a boundary of the suction cup; and a pump configured to evacuate the cavity through the valve.

Example 14 includes the device of Example 13, in which the pressure sensor includes a wireless transmitter configured to transmit pressure data that corresponds to the pressure in the cavity between the suction cup and the chest of the patient.

Example 15 includes the device of any of Examples 13-14, in which the valve is further configured to substantially prevent air from entering the cavity through the valve.

Example 16 includes the device of any of Examples 13-15, in which the valve is further configured to allow air to enter the cavity through a boundary of the suction cup.

Example 17 includes the device of any of Examples 13-16, in which the pump is removably attached to the valve.

Example 18 includes the device of any of Examples 13-17, in which the pump is incorporated within an envelope of the suction cup.

Example 19 includes the device of any of Examples 13-18, in which the valve and the pump are removably attached to the suction cup as a single unit.

Example 20 includes the device of any of Examples 13-19, in which the pump is substantially toroidal and coupled to an upper surface of the suction cup.

Example 21 includes the device of any of examples 13-20, in which the pump is a fixed-volume syringe, the fixed-volume syringe having a spring configured to prevent the fixed-volume syringe from evacuating the cavity beyond a threshold of safe attachment force.

Example 22 includes a device for applying compressions to a chest of a patient, the device comprising: a piston; a suction cup configured to contact the chest of the patient and coupled to the piston at a piston interface of the suction cup; and a valve configured to allow air to exit a cavity through a boundary of the suction cup, the cavity being between the suction cup and the chest of the patient, the valve comprising a flexible lip at the piston interface of the suction cup.

Example 23 includes the device of Example 22, further comprising a pressure sensor between the suction cup and the chest of the patient, the pressure sensor being configured to measure a pressure in the cavity between the suction cup and the chest of the patient.

Example 24 includes the device of Example 23, in which the pressure sensor includes a wireless transmitter configured to transmit pressure data that corresponds to the pressure in the cavity between the suction cup and the chest of the patient.

Example 25 includes a method for detecting detachment of a suction cup of a mechanical CPR device from a chest of a patient, the method comprising the steps of: measuring, with a pressure sensor located between the suction cup and the chest of the patient, an initial pressure in a cavity of the suction cup when the suction cup is attached, the cavity being between the suction cup and the chest of the patient; storing, in a memory, the measured initial pressure; controlling a compression mechanism of the mechanical CPR device to deliver a series of compressions to the chest of the patient; measuring, with the pressure sensor, a current pressure in the cavity of the suction cup; calculating a difference between the measured current pressure and the initial pressure; and determining whether the difference between the measured current pressure and the initial pressure exceeds a preset threshold.

Example 26 includes the method of Example 25, further comprising the steps of generating a human perceptible alert indicating the suction cup has detached from the chest of the patient when the difference between the measured current pressure and the initial pressure exceeds a preset threshold.

Example 27 includes the method of any of Examples 25-26, further comprising the step of controlling the compression mechanism to stop delivering compressions to the chest of the patient when the difference between the measured current pressure and the initial pressure exceeds a preset threshold.

Example 28 includes the method of any of Examples 25-27, further comprising the step of controlling the compression mechanism to begin delivering low amplitude compression and lifts to the chest of the patient to reattach the suction cup when the difference between the measured current pressure and the initial pressure exceeds a preset threshold.

Example 29 includes a method for attaching a suction cup of a mechanical CPR device to a chest of a patient, the method comprising the steps of: pressing a sealing lip of the suction cup to the chest of the patient; evacuating a cavity of the suction cup through a valve, the cavity being between the suction cup and the chest of the patient, and the valve being configured to allow air to exit the cavity through a boundary of the suction cup.

Example 30 includes the method of Example 29, in which evacuating the cavity of the suction cup through the valve comprises pumping air out of the cavity.

Example 31 includes the method of Example 30, in which pumping air out of the cavity comprises using a hand pump with a flexible bulb configured to be manually squeezed.

Example 32 includes the method of Example 30, in which pumping air out of the cavity comprises using a fixed-volume syringe.

Example 33 includes the method of Example 30, in which pumping air out of the cavity comprises using an electric pump.

Example 34 includes the method of Example 30, in which pumping air out of the cavity comprises using compressed air to lower pressure at the valve.

Example 35 includes the method of Example 30, in which pumping air out of the cavity comprises using a pump incorporated within an envelope of the suction cup.

Example 36 includes the method of Example 30, in which pumping air out of the cavity comprises using a substantially toroidal pump coupled to an upper surface of the suction cup.

Example 37 includes the method of Example 30, in which pumping air out of the cavity comprises using a pump removably attachable to the valve.

Example 38 includes the method of any of Examples 29-37, further comprising the steps of: measuring, with a pressure sensor located between the suction cup and the chest of the patient, an initial pressure in the cavity; comparing the initial pressure to a preset maximum pressure to be allowed within the cavity; and determining whether the initial pressure is below the preset maximum pressure.

Example 39 includes a device for applying compressions to a chest of a patient, the device comprising: a suction cup configured to contact the chest of the patient, a cavity being between the suction cup and the chest of the patient; and a valve configured to allow air to enter a cavity through a boundary of the suction cup to increase an air pressure within the cavity to an amount that is less than an ambient pressure outside the boundary of the suction cup.

Example 40 includes the device of any Example 39, further comprising a pressure sensor configured to measure the air pressure in the cavity.

Example 41 includes the device of Example 40, in which the pressure sensor includes a wireless transmitter configured to transmit pressure data that corresponds to the air pressure in the cavity.

Example 42 includes the device of Example 39-41, in which the valve is further configured to allow air to exit the cavity through the boundary of the suction cup to decrease the air pressure within the cavity.

Example 43 includes the device of any of Examples 39-42, further comprising a pump configured to evacuate the cavity through the valve.

Example 44 includes the device of Example 43, in which the pump is removably attached to the valve.

Example 45 includes the device of any of Examples 43-44, in which the pump is incorporated within an envelope of the suction cup.

Example 46 includes the device of any of Examples 43-45, in which the valve and the pump are removably attached to the suction cup as a single unit.

Example 47 includes the device of any of Examples 43-46, in which the pump is substantially toroidal and coupled to an upper surface of the suction cup.

Example 48 includes the device of any of Examples 43-47, in which the pump is a fixed-volume syringe, the fixed-volume syringe having a spring configured to prevent the fixed-volume syringe from evacuating the cavity beyond a threshold of safe attachment force.

Example 49 includes the device of any of Examples 43-48, in which the pump comprises a spring and bellows within the suction cup, the bellows configured to force air from the cavity through the valve, the spring configured to return the bellows to an uncompressed condition.

Example 50 includes the device of Example 49, in which the bellows is separated from the cavity by a valve that allows air to pass from the cavity into the bellows.

Example 51 includes a mechanical cardio-pulmonary resuscitation (CPR) device, comprising: a compression mechanism configured to perform successive CPR compressions to a chest of a patient, the compression mechanism comprising: a housing, a piston, a suction cup at an end of the piston, the suction cup configured to contact the chest of the patient, a cavity being between the suction cup and the chest of the patient, and a valve configured to allow air to enter a cavity through a boundary of the suction cup to increase an air pressure within the cavity to an amount that is less than an ambient pressure outside the boundary of the suction cup; and a support structure comprising: a backboard configured to be placed underneath the patient; and a support leg configured to support the chest compression mechanism at a distance from the backboard.

Example 52 includes the CPR device of any Example 50, further comprising a pressure sensor configured to measure the air pressure in the cavity.

Example 53 includes the CPR device of Example 52, in which the pressure sensor includes a wireless transmitter configured to transmit pressure data that corresponds to the air pressure in the cavity.

Example 54 includes the CPR device of any of Examples 50-53, in which the valve is further configured to allow air to exit the cavity through the boundary of the suction cup to decrease the air pressure within the cavity.

Example 55 includes the CPR device of any of Examples 51-54, further comprising a pump configured to evacuate the cavity through the valve.

Example 56 includes the CPR device of Example 55, in which the pump is removably attached to the valve.

Example 57 includes the CPR device of any of Examples 55-56, in which the pump is incorporated within an envelope of the suction cup.

Example 58 includes the CPR device of any of Examples 55-57, in which the valve and the pump are removably attached to the suction cup as a single unit.

Example 59 includes the CPR device of any of Examples 55-58, in which the pump is substantially toroidal and coupled to an upper surface of the suction cup.

Example 60 includes the CPR device of any of Examples 55-59, in which the pump is a fixed-volume syringe, the fixed-volume syringe having a spring configured to prevent the fixed-volume syringe from evacuating the cavity beyond a threshold of safe attachment force.

Example 61 includes the CPR device of any of Examples 55-60, in which the pump comprises a spring and bellows within the suction cup, the bellows configured to force air from the cavity through the valve, the spring configured to return the bellows to an uncompressed condition.

Example 62 includes the CPR device of Example 61, in which the bellows is separated from the cavity by a valve that allows air to pass from the cavity into the bellows.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the CPR device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

I (or We) claim:

1. A device for applying compressions to a chest of a patient, the device comprising:
a suction cup configured to contact the chest of the patient;
a valve configured to allow air to exit a cavity through a boundary of the suction cup, the cavity being between the suction cup and the chest of the patient; and
a pump configured to evacuate the cavity through the valve.

2. The device of claim 1, further comprising a pressure sensor configured to measure a pressure in the cavity.

3. The device of claim 2, in which the pressure sensor includes a wireless transmitter configured to transmit pressure data that corresponds to the pressure in the cavity.

4. The device of claim 1, in which the valve is further configured to substantially prevent air from entering the cavity through the valve.

5. The device of claim 1, in which the valve is further configured to allow air to enter the cavity through the boundary of the suction cup.

6. The device of claim 5, in which the valve is configured to allow air to enter the cavity to increase a pressure within the cavity to an amount that is less than an ambient pressure outside the boundary of the suction cup.

7. The device of claim 1, in which the pump is removably attached to the valve.

8. The device of claim 1, in which the pump is incorporated within an envelope of the suction cup.

9. The device of claim 1, in which the valve and the pump are removably attached to the suction cup as a single unit.

10. The device of claim 1, in which the pump is substantially toroidal and coupled to an upper surface of the suction cup.

11. The device of claim 1, in which the pump is a fixed-volume syringe, the fixed-volume syringe having a spring configured to prevent the fixed-volume syringe from evacuating the cavity beyond a threshold of safe attachment force.

12. The device of claim 1, in which the pump comprises a spring and bellows within the suction cup, the bellows configured to force air from the cavity through the valve, the spring configured to return the bellows to an uncompressed condition.

13. The device of claim 12, in which the bellows is separated from the cavity by a valve that allows air to pass from the cavity into the bellows.

14. A mechanical cardio-pulmonary resuscitation (CPR) device, comprising:
a compression mechanism configured to perform successive CPR compressions to a chest of a patient, the compression mechanism comprising:
a housing,
a piston,
a suction cup at an end of the piston, the suction cup configured to contact the chest of the patient, a cavity being between the suction cup and the chest of the patient, and
a valve configured to allow air to enter a cavity through a boundary of the suction cup to increase an air pressure within the cavity to an amount that is less than an ambient pressure outside the boundary of the suction cup; and
a support structure comprising:
a backboard configured to be placed underneath the patient; and
a support leg configured to support the chest compression mechanism at a distance from the backboard.

15. The CPR device of claim 14, further comprising a pressure sensor configured to measure the air pressure in the cavity.

16. The CPR device of claim 15, in which the pressure sensor includes a wireless transmitter configured to transmit pressure data that corresponds to the air pressure in the cavity.

17. The CPR device of claim 14, in which the valve is further configured to allow air to exit the cavity through the boundary of the suction cup to decrease the air pressure within the cavity.

18. The CPR device of claim 17, further comprising a pump configured to evacuate the cavity through the valve.

19. The CPR device of claim 18, in which the pump is removably attached to the valve.

20. The CPR device of claim 18, in which the pump is incorporated within an envelope of the suction cup.

21. The CPR device of claim 18, in which the valve and the pump are removably attached to the suction cup as a single unit.

22. The CPR device of claim 18, in which the pump is substantially toroidal and coupled to an upper surface of the suction cup.

23. The CPR device of claim 18, in which the pump is a fixed-volume syringe, the fixed-volume syringe having a spring configured to prevent the fixed-volume syringe from evacuating the cavity beyond a threshold of safe attachment force.

24. The CPR device of claim 18, in which the pump comprises a spring and bellows within the suction cup, the bellows configured to force air from the cavity through the valve, the spring configured to return the bellows to an uncompressed condition.

25. The CPR device of claim 24, in which the bellows is separated from the cavity by a valve that allows air to pass from the cavity into the bellows.
